(19) United States
(12) Patent Application Publication
(10) Pub. No.: US 2004/0266421 A1
(43) Pub. Date: Dec. 30, 2004

(54) IP phone system

(76) Inventors: Shinta Kato, Kanagawa- Ken (JP); Hiromitsu Miyamoto, Tokyo (JP)

Correspondence Address: RABIN & Berdo, PC, 1101 14TH STREET, NW, SUITE 500, WASHINGTON, DC, 20005, US

(21) Appl. No.: 10/732,354

(22) Filed: Dec. 11, 2003

(30) Foreign Application Priority Data
Jun. 27, 2003 (JP) 184717/2003

(51) Int. Cl. H04Q 7/20

(52) U.S. Cl. 455/422.1

(57) ABSTRACT

Disclosed is an IP (Internet Protocol) phone system that performs communication through packet exchange by VoIP (Voice over IP) and ensures the use of child terminal devices which are cordless telephone terminals. In the IP phone system, a computer device having an H.323 gate keeper function, a plurality of computer devices having a protocol conversion function and IP phones are connected to an IP network, identifiers of child terminal devices are respectively registered in the latter computer devices. When a Piconet of a communication link among the computer devices and the child terminal devices is formed, one of the child terminal devices makes a call to a desired terminal and executes voice communication over an IP network.

### BACKGROUND OF THE INVENTION

1. Field of the Invention

The present invention relates to an IP (Internet Phone) phone system which has telephone terminals in an IP network and executes communication through packet exchange by VoIP (Voice over Internet Phone), e.g., an IP phone system that ensures the use of child terminal devices which are cordless telephone terminals.

2. Description of the Related Art

Recently, multimedia communication in which voice, video and data information are transmitted and received using the Internet protocol (IP) is carried out over an IP network. To standardize such communication, for example, ITU-T (International Telecommunication Union-Telecommunication) sets the standards of the H.300 series.

Of the standards, H.323 has been used for communication of telephone systems as voice communication and includes standards for call control needed to execute, for example, VoIP (Voice over IP).

As a system structure to effect VoIP communication h, an IP phone exchange system is constructed by connecting an H.323 gateway device which holds telephone circuits, such as analog circuits or PHS circuits, and has a function to perform protocol conversion with respect to a different communication network and an H.323 gate keeper device which has a function to control exchange connection to an IP network. This IP phone system provides a telephone exchange service which has been carried out by the conventional exchange system.

IP phones can be connected directly to the IP network over which such an IP phone exchange system is constructed. An IP phone is a telephone for an IP phone exchange system which can operate and execute voice communication in the same way as the conventional telephones do under the control of an H.323 gate keeper device. In an environment such as an office where multiple personal computers or the like are connected to a LAN, it is possible to connect a plurality of IP phones to the intranet to ensure communication among the IP phones, and also allow a telephone terminal, included in a telephone system constructed by analog telephone circuits or digital circuits, to communicate with an IP phone via an H.323 gateway device which performs protocol conversion between networks.

It is also possible to permit an IP phone system to accommodate a plurality of extension telephones by forming an IP exchange by installing a PBX device in an H.323 gateway device and providing a plurality of telephones. In case where a PHS telephone terminal, for example, is used as an extension telephone, a LAN cordless telephone system is constructed by connecting a plurality of PHS base stations to an IP exchange.

Further, achievement of a wireless network which, like PHS telephone terminals, executes information communication wirelessly is expected. For example, Bluetooth which employs the close-range wireless communication technology can perform information communication by connecting electronic devices within a communication area wirelessly.

For the details of the prior arts, please refer to Japanese Patent Laid-Open No. 2001-285476 and Japanese Patent Laid-Open No. 2002-354144.

To construct a cordless telephone system by letting an IP exchange accommodate PHS telephone terminals, however, PHS telephone circuits should be laid out from the H.323 gate keeper device to the PHS base stations. This inevitably requires equipment and construction costs and a construction work period. In addition, PHS telephone circuits are lines separate from an IP network, thus disabling the effective use of an IP network already constructed within a LAN.

In case of constructing a system which provide multiple IP phones in an IP exchange system, IP address according to the number of IP phones to be connected are further needed so that the provision of a plurality of computer terminals and a plurality of IP phones result in insufficient IP addresses.

Further, as voice packets are transferred over an IP network even for extension communication between IP phones via an IP exchange, an increase in the traffic of the extension would increase the amount of packet transfer. This would lower the performance, such as other data transfer between personal computers.

### SUMMARY OF THE INVENTION

Accordingly, it is an object of the invention to overcome the shortcomings of the prior arts and provide an IP phone system that performs communication through packet exchange by VoIP and ensures the use of child terminal devices which are cordless telephone terminals

To achieve the object, according to one aspect of the invention, there is provided an IP phone system which is connected to an Internet protocol (IP) network over which packet communication are carried out using an Internet protocol, executes voice communication by VoIP (Voice over IP) that exchanges voice packets using the Internet protocol, and includes a computer device, connected to the IP network which is connected to the IP network and perform protocol conversion between the Internet protocol and another wireless communication protocol; a first child terminal device which connects to the computer device by wireless communication by the wireless communication protocol and executes voice communication with another telephone terminal over that IP network to which the computer device is connected; and a gate keeper device which is connected to the IP network and executes call control with respect to the computer device. A same identifier according to the wireless communication protocol is set to the computer device and the first child terminal device and whereby the computer device performs call and reception control when a communication link to the first child terminal device is formed.

In this case, the IP phone system may include a second child terminal device-which connects to the computer device by wireless communication by the wireless communication protocol and executes voice communication with another telephone terminal over that IP network to which the computer device is connected, and an identifier different from that set to the computer device may be set to the second child terminal device, and in case where a communication link to the second child terminal device is formed, the computer device may perform call control according to a decision on whether a calling process is possible or not when detecting ringing from the second child terminal device.

It is preferable that the computer device should perform reception control in case where a communication link to the first child terminal device is formed when detecting an incoming call from the IP network, or that the computer device should set identifiers respectively corresponding to a plurality of first child terminal devices in accordance with a reception priority order and perform reception control for the first child terminal devices to which the identifiers according to the reception priority order are set, when detecting an incoming call from the IP network.

Further, it is preferable that when detecting an incoming call from the IP network, the computer device should notify absence information to the gate keeper device in case where a communication link to the first child terminal device is not formed, or that when detecting an incoming call from the IP network, the computer device should return an absence message to a caller in case where a communication link to the first child terminal device is not formed.

The gate keeper device may be a gate keeper which has an H.323 communication control function, or the computer device may have a gateway function which performs protocol conversion.

It is preferable that the computer device should have a communication interface circuit which conforms to a Bluetooth (registered trademark) technical specification, and perform protocol conversion between a wireless communication protocol according to the technical specification and the Internet protocol. It is also preferable that the first child terminal device should have a communication interface circuit which conforms to a Bluetooth technical specification.

### BRIEF DESCRIPTION OF THE DRAWINGS

FIG. 1 is a block diagram illustrating an example of the structure of an IP phone system to which the present invention is adapted;

FIG. 2 is a block diagram showing the internal functional structure of a computer device;

FIG. 3 is a block diagram showing an example of the internal structure of a child terminal device;

FIG. 4 is a diagram illustrating an operation to make a call to an IP phone via the computer device of a registered parent device from a child terminal device;

FIG. 5 is a diagram illustrating an operation to make a call to an IP phone via the computer device of an unregistered parent device from a child terminal device;

FIG. 6 is a diagram illustrating an operation to make a call to a child terminal device from an IP phone; and

FIG. 7 is a diagram illustrating an operation in case where a Piconet is not formed by a child terminal device and a computer device which is a registered parent device at the time an IP phone makes a call to the child terminal device.

### DETAILED DESCRIPTION OF THE PREFERRED EMBODIMENT

An embodiment of an IP phone system according to the present invention will be described in detail below with reference to the accompanying drawings.

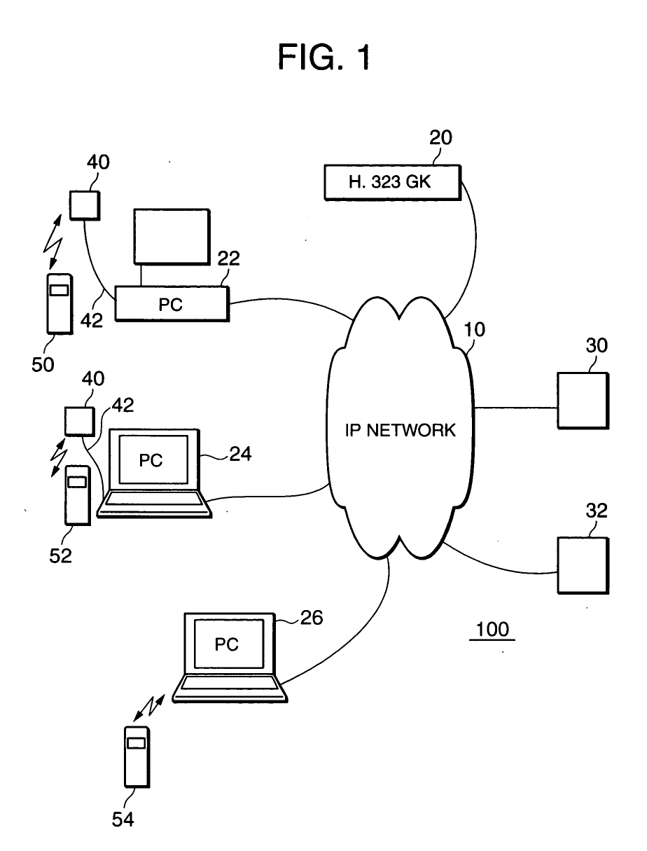

FIG. 1 illustrates one embodiment of an IP phone system 100 on an intranet in which a plurality of computer devices 20, 22, 24 and 26 and IP phones 30 and 32 are connected to an Internet protocol (IP) network 10 over which communication by the Internet protocol is executed.

The computer device (GK) 20 is an H.323 gate keeper (GK) device which conforms to the international standard H.323 according to the ITU-T Recommendation and has various processing functions to control a telephone service. In this embodiment, the computer device 20 registers the IP phones 30 and 32 and the computer devices 20, 22, 24 and 26, connected to the IP network 10, as end points and manages those terminals as zones in order to achieve a telephone service by VoIP (Voice over IP) on the IP network 10. The computer device 20 has a function for address management, such as address resolution by a controlled zone with respect to a terminal, and a communication control function such as call control and band limitation.

The computer devices 22, 24 and 26 are personal computers (PCs) having an H.323 gateway function and IP addresses to identify network devices are respectively set to the computer devices 22, 24 and 26.

As illustrated, communication units 40 and 42 which have a close-range wireless communication technology interface circuit are respectively connected to the computer devices 22 and 24 via an interface 42 such as USB. In this embodiment, the Bluetooth technical specification is adapted to the computer devices 22, 24 and 26 as the close-range wireless communication technology.

According to the close-range wireless communication technology, the computer devices 22, 24 and 26 form wireless links to child terminal devices 50, 52 and 54 in a communication area. For example, the computer device 2 and the child terminal device 50 are connected together by the close-range wireless communication technology to form a Piconet comprising a master and a slave and the child terminal device 50 makes a call to effect voice communication. The same address or identifier (BD_ADDR) has been set and registered in the computer device 22 and the child terminal device at the time the usage of the system starts, and the computer device 22 serves as a parent device to the child terminal device 50. Unique identifiers (BD_ADDR) different from one another are respectively given to the child terminal devices 50, 52 and 54.

The computer devices 22 and 24 likewise respectively register and manage identifiers (BD_ADDR) of the same numbers with respect to the child terminal devices 52 and 54.

Each computer device 22, 24 or 26 has a function to accept a call from the child terminal device 50, 52 or 54 in which the same identifier as that of the associated child terminal device and perform a call processing to the IP network 10. Further, each computer device 22, 24 or 26 also has a function to determine whether or not the call can be processed and perform a call process to the IP network 10, if the process is possible, when detecting a call from a child terminal device in which an identifier different from the one set in the local computer device.

Each computer device 22, 24 or 26 has such a function that when detecting a call received by the child terminal device 50, 52 or 54 in which the same identifier is registered over the IP network 10, the computer device accepts the received call and connects a registered child terminal device in case where it forms a Piconet with that child terminal device, but sends absence notification to the computer device (GK) 20 on the IP network 10 in case where a Piconet is not formed.

The child terminal devices 50, 52 and 54 are cordless telephone terminals each of which has a close-range wireless communication technology interface circuit according to the Bluetooth technical specification and a VoIP processing function and serves a cordless child device with respect to the associated one of the computer devices 22, 24 and 26 having communication interfaces according to the same technical specification.

The computer device 26 incorporates a communication control circuit having the same function as the communication unit 40. Of course, this communication control circuit may be constructed in such a way as to be loaded into a card slot.

Those computer devices 22, 24 and 26 are placed on desks or the like located in, for example, an office and are connected to the IP network 10 via unillustrated LAN interface circuits.

The IP phone (IP-TEL) 30, 32 is a telephone terminal for the IP network which makes and receives a call by sending an IP packet acquired by assembling voice signals into an IP packet to the IP network 10, breaking down an IP packet sent from the IP network 10 to voice signals. IP addresses to identify the IP phones 30 and 32 are set in the IP phones 30 and 32 respectively. The IP phones 30 and 32, like the computer devices 22, 24 and 26, in the embodiment are H.323 end points which perform telephone communication by VoIP (Voice over IP) in conformity with the International standard H.323.

As apparent from the above, the child terminal device 50 perform a conversion process of a voice and a packet by VoIP, exchanges voice packets with the computer devices 22, 24 and 26, connected to them over a network, by the close-range wireless communication technology, and as the computer device 22, 24 or 26 serves as a parent device, it can establish call connection to, for example the IP phone 30, 32 or another child terminal device which cannot directly form a Piconet and perform voice communication.

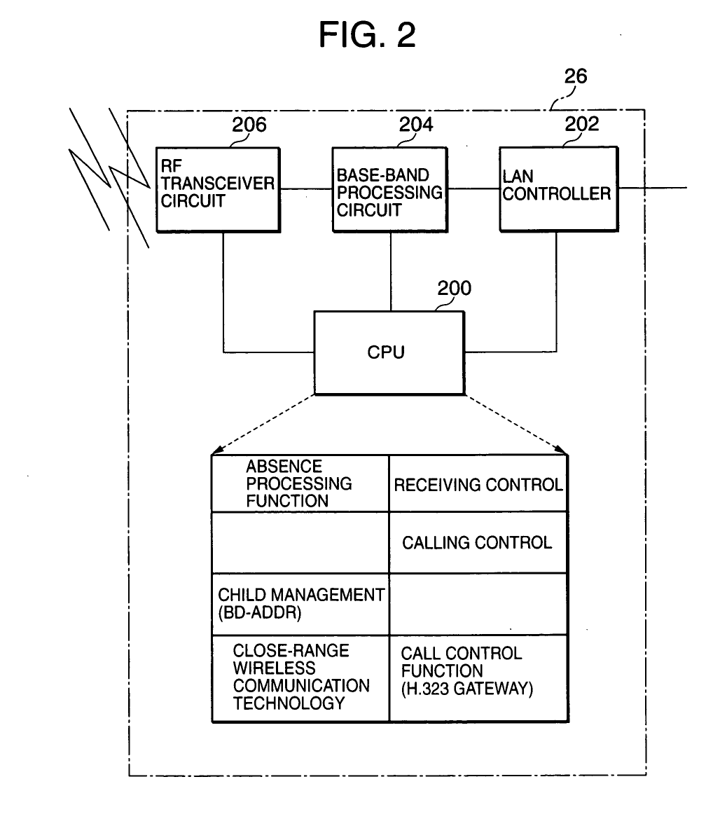

Referring now to FIG. 2, a description will be given of an example of the internal structure of the computer device 26 in the computer devices 22, 24 and 26 which incorporates the close-range wireless communication technology interface circuit. The computer device 26 has a central processing unit (CPU) 200 which includes the basic circuits of a personal computer, such as an input/output circuit, a display circuit, a memory circuit, a peripheral circuit like an arithmetic operation circuit, a memory device where application software or the like is stored, and so forth.

A LAN controller 202, a base-band processing circuit 204 and an RF transceiver circuit 206 are connected to the CPU 200 via predetermined bus interfaces. The LAN controller 202 is a network interface card which is connected to the IP network 10 to send and receive an IP packet.

The base-band processing circuit 204 and the RF transceiver circuit 206 constitute an interface circuit to which the aforementioned close-range wireless communication technology is adapted. The base-band processing circuit 204 is a processing circuit which performs protocol conversion between an IP packet and a packet according to the close-range wireless communication technology and controls a communication link by executing communication management, such as construction of a Piconet, and frequency and timing control.

The RF transceiver circuit 206 is a physical layer circuit which includes a modulation/demodulation circuit for wireless communication in a frequency hopping spectrum spread system in a 2.4-GHz frequency band called an ISM band. In the embodiment, the RF transceiver circuit 206 includes an antenna for transmitting and receiving radio frequency signals and has a function to execute transmission power control according to the invention the reception strength of received radio waves.

The CPU 200 has an H.323 gateway function which registers the computer device 26 as an end point in the computer device (GK) 20 connected to the IP network 10 and connects the IP network 10 to the child terminal device 54 or the like that uses the close-range wireless communication technology to exchange call control information and voice packets or so.

The CPU 200 provides a call control function to process calling from the child terminal device 54 and calling to a child terminal device by executing call and reception control with respect to the IP network 10.

The CPU 200 of the computer device 26 has a function to set and register the same number as the identifier (BD_ADDR) which is set and registered in, for example, the child terminal device 54 and manage the child terminal device as its own registered child device and has a conversion table of the identifiers (BD_ADDR) and telephone numbers assigned to the end points. The CPU 200 sets and registers the identifiers (BD_ADDR) of a maximum of seven child terminal devices. In this case, as the priority order is set for each child terminal device, the CPU 200 can ring the child terminal devices in the order according to the invention the priority order at the time of, for example, reception.

The CPU 200 further has a function to accept and process a call from the child terminal device 54 at the time a Piconet is formed with the child terminal device 54, a function to connect to the child terminal device and establish call connection between the child terminal device 54 and the calling terminal device on-the IP network when there comes a call from the IP network 10 at the time of forming the Piconet. The CPU 200 also has a function to notify the caller of absence notification information indicting that the child terminal device 54 is absent. This function is notified to the caller as a telephone service via the computer device 20. In this case, the computer device 26 may perform a reception process and return an absence message to the caller.

In the embodiment, the CPU 200 further has such a processing function that when detecting a call request from another child terminal device 50, 52 or the like or a child device unregistered in the local computer device is detected at the time a Piconet is formed with that unregistered child device, the CPU 200 accepts the call, if processable, on behalf of the registered parent device and performs a process to establish call connection to the IP network 10.

The CPU 200 is loaded with application software or so for an ordinary work, so that the aforementioned process control functions and various kinds of software can work on a predetermined operating system.

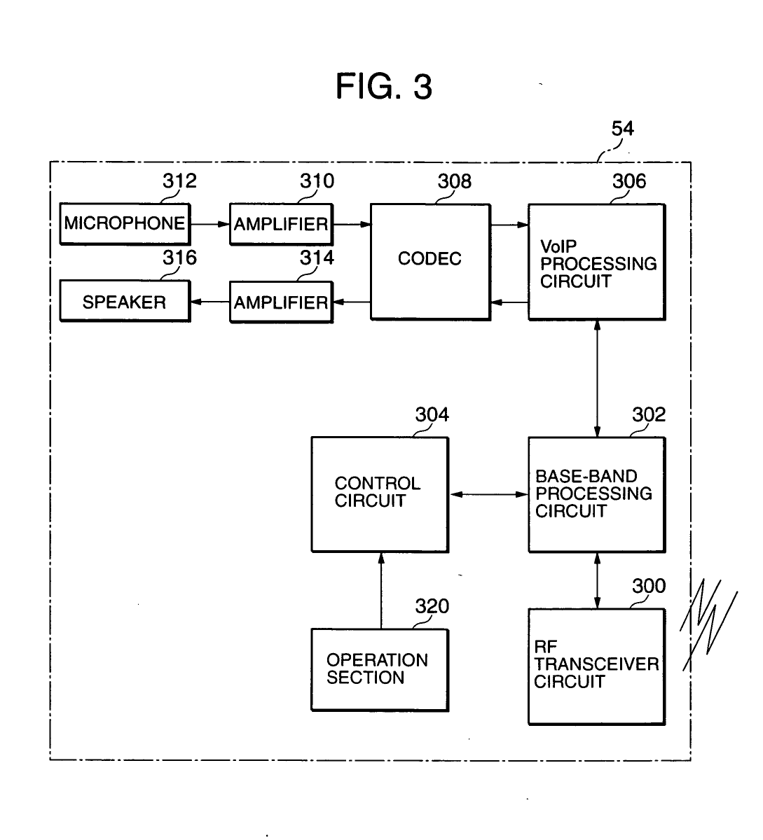

FIG. 3 shows an example of the internal structure of the child terminal devices 50, 52 and 54. As those child terminal devices 50, 52 and 54 differ from one another in that identifiers of different values are respectively set to them and may be identical in other functional structures, the child terminal device 54 will be discussed as a representing example.

As illustrated, the child terminal device 54 has an RF transceiver circuit 300 and a base-band processing circuit 302 that constitute an interface circuit to which the close-range wireless communication technology is adapted.

The RF transceiver circuit 300 may have the same circuit structure as the RF transceiver circuit 206 shown in FIG. 2 and is a radio frequency circuit which executes wireless communication in a frequency hopping spectrum spread system in the 2.4-GHz frequency band. The RF transceiver circuit 300 includes an antenna for transmitting and receiving radio frequency signals and has a function to execute transmission power control according to the invention the reception strength of received radio waves. The input and output of the RF transceiver circuit 300 are connected to the base-band processing circuit 302.

The base-band processing circuit 204 may have the same circuit structure as the base-band processing circuit 204 shown in FIG. 2 and is a-processing circuit which, under the control of a control circuit 304, performs protocol conversion between an IP packet formed by a VoIP process and a packet according to the close-range wireless communication technology and controls a communication link by executing communication management, such as construction of a Piconet, and frequency and timing control. The input and output of the base-band processing circuit 302 are connected to a VoIP processing circuit 306.

The VoIP processing circuit 306 has a voice-packet deassembling/assembling function to assemble voice signals into an IP packet and extract voice signals by breaking down the IP packet, and a function to generate a control packet concerning ringing and voice communication. The VoIP processing circuit 306 is further connected to a CODEC 308,

A microphone 312 is connected via an amplifier 310 to the CODEC 308 and a speaker 316 is connected via an amplifier 314 to the other side of the CODEC 308. The CODEC 308 includes a coding circuit which performs a predetermined coding process on voice signals converted by the microphone 312 and a modulation circuit which generates voice signals by demodulating coded data output from the VoIP processing circuit 306. The CODEC 308 performs a conversion process by, for example, a standardized voice coding system such as G.711 or G.729.

The control circuit 304 is a processing circuit which performs general control of the individual sections of the child terminal device 54 to execute call generation and reception control. At the time of calling and call reception, the control circuit 304 detects an operation on an operation section 320 and performs control according to the operation information. The control circuit 304 and operation section 320 may be constructed by using the functional structures of a portable information terminal, such as a personal digital assistant (PDA). In this case, the other functional circuits should mounted on the portable information terminal via a card interface or the like. The same identifier as the identifier (BD_ADDR) which is set to the computer device 26 as a parent device is set and registered in the control circuit 304.

At the time the child terminal device 54 forms a Piconet with the computer device 26 as a parent device, the child terminal device 54 makes a call request to the parent device, and when the computer device 26 gets an incoming call from the IP network 10 at the time of forming the Piconet and the child terminal device 54 receives ringing from the computer device 26, the child terminal device 54 makes response connection to thereby establish call connection of the child terminal device 54 to the calling terminal device on the IP network 10.

Further, the child terminal device 54 has such a function that at the time the child terminal device 54 forms a Piconet with another computer device 22, 24 which is not the parent device where the child terminal device 54 is registered, the child terminal device 54 sends call information to the computer device with which the Piconet is formed when detecting a call operation, and performs a talk process after establishment of call connection when the information is received.

The child terminal devices 50, 52 and 54 can form a Piconet with one another and can establish direct wireless communication among the child terminal devices 50, 52 and 54 under no management of the registered parent devices. In this case, the control circuit 304 has a function to control an extension telephone for voice communication.

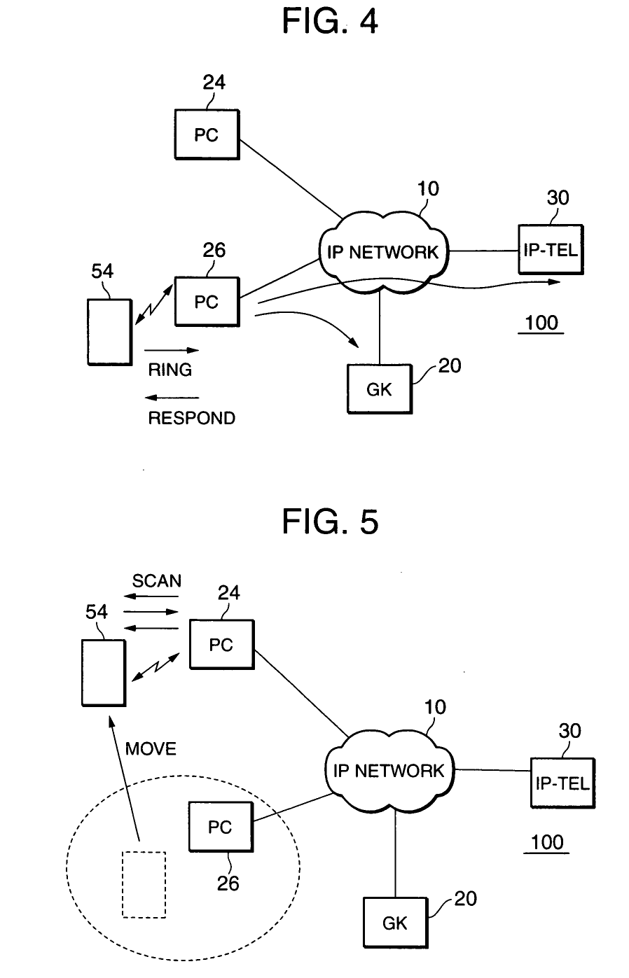

The operation of the IP phone system 100 with the above-described structure will be discussed referring to FIGS. 4 to 7. First, an operation of establishing call connection as the child terminal device 54 makes a call to the IP phone (IP-TEL) 30 via the computer device (PC) 26 as the registered parent device will be discussed referring to FIG. 4.

As illustrated, with a Piconet formed by the child terminal device 54 and the computer device 26 by a communication link, when the child terminal device 54 detects a calling operation, ringing is made to the computer device 26. When the computer device 26 detects ringing from the child terminal device 54 which is a registered child device and recognizes the identifier, the computer device 26 sends call setting to the computer device (GK) 20. When detecting its response, the computer device 26 informs the child terminal device 54 that a session has been established and controls the child terminal device 54 into a talk state. This can allow the. child terminal device 54 to talk to the IP phone 30.

Next, a description will be given of a case where the child terminal device 54 moves out of the communication area of the computer device 26, enters the communication area of another computer device 24 and forms a Piconet, as shown in FIG. 5. The child terminal device 54 responds to scanning from the computer device 26 which is an unregistered parent device, and a Piconet is formed in accordance with the decision made by the computer device 24.

When the child terminal device 54 detects a calling operation, ringing is made to the computer device 24. When the computer device 24 detects ringing from the child terminal device 54 which is an unregistered child device and recognizes the identifier, the computer device 24 sends call setting to the computer device (GK) 20 to perform a ringing process if the ringing process is acceptable. It is apparent that in case where the computer device 24 can process ringing from even a child terminal device whose identifier indicates an unregistered child terminal device, the computer device 24 can operate in place of the registered parent device. The other computer devices 22 and 26 can likewise perform processes for unregistered child devices in place of the registered parent devices.

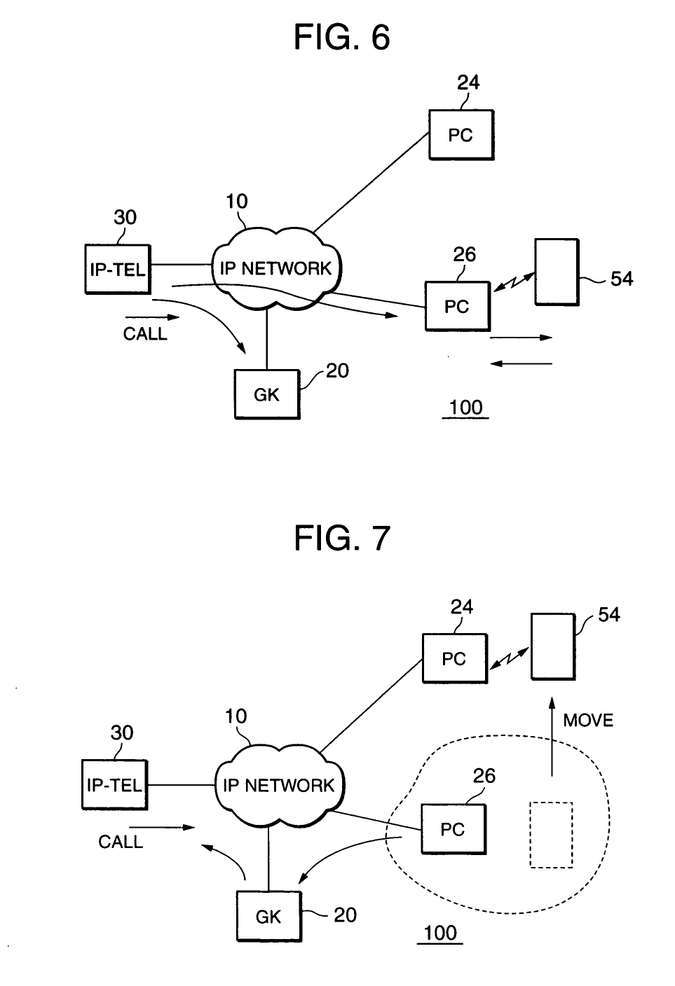

Next, an operation performed at the time the IP phone 30 makes a call to the computer device 26 will be discussed referring to FIG. 6. First, a Piconet of the computer device 26 and the child terminal device 54 is formed in the communication area. When a call operation on the IP phone 30 is performed, a ringing setting process and establishment of a session are carried out and an IP packet sent from the IP phone 30 is delivered to the computer device 26. The computer device 26 notifies an incoming call to the child terminal device 54 as a registered child device whose identifier is registered When a user performs an Off-hook operation on the child terminal device 54 upon reception of the notification, the child terminal device 54 informs the computer device 26 of the operation information and starts a talk process. The computer device keeps and manages talking between the child terminal device 54 and the IP network.

Referring to FIG. 7, the following discusses an operation at the time an incoming call to the computer device 26 is generated in case where the child terminal device 54 moves out of the communication area of the computer device 26 as a registered parent device.

Even when the computer device 26 notifies an incoming call to the child terminal device 54, it does not receive a response from the child terminal device 54. As the computer device 26 recognizes that a Piconet is not formed with the child terminal device 54 as a registered child device, after the passage of a predetermined time, the computer device 26 decides that the child terminal device 54 is unable to respond and returns an absence notification packet, which notifies the absence of the child terminal device to the calling IP phone 30, to the computer device (GK) 20. Upon reception of this absence notification packet, the computer device (GK) 20 sends notification indicating the absence to the IP phone 30 or can provide the IP phone 30 with a telephone service or the like, for example, a message recording process.

In case where a plurality of identifiers are registered in the computer device 26 and a child terminal device whose registered identifier is different from the identifier of the child terminal device 54 has a Piconet formed within the communication area, the computer device 26 notifies an incoming call to the child terminal devices in the order according to the registration order. When the computer device 26 can acknowledge that child terminal device which has responded to the notification properly, the computer device 26 connects that child terminal device and starts talking. The computer device 26 may be constructed in such a way that when deciding that such a child terminal device is absent, the computer device 26 prepares, for example, an absence message and sends it to the calling IP phone 30 in response to the ringing.

As described above, the IP phone system 100 does not requires separate provision of the H.323 gateway and PHS base stations and can thus construct a simple cordless telephone system with a reduced equipment cost. Further, a cordless telephone system can be constructed by preparing child telephone terminals in an environment where there is a computer device equipped with the close-range wireless communication technology interface and connected to a network and installing the gateway function including a H.323 based call control function in the computer device. This eliminates the system construction period and can ensure easy and fast installation. Furthermore, as extension telephones can be integrated by a LAN or communication among child devices can be used as extension talking, a traffic increase on the LAN can be prevented.

In short, a cordless telephone system can be constructed in an environment where there is a computer device connected to a network without setting a greater number of IP addresses to each of child terminal devices.

According to the invention, as described above, a computer device which performs protocol conversion between the Internet protocol and another wireless communication protocol and a gate keeper device which performs call control with respect to the computer device are connected to an IP network such as an intranet, and the computer device takes such a structure as to set and register a first child terminal device which is connected through wireless communication by a wireless communication protocol and carries out voice communication with another telephone terminal over the IP network. This structure eliminates the need to set an IP address to the first child terminal device, thus avoiding a possible case of addresses becoming insufficient, and can ensure calling and reception via the computer device as a parent device. In this case, wireless communication protocol is converted to the Internet protocol by the computer device so that a plurality of first child terminal devices which serve as cordless child devices can be installed without requiring a work of siting base stations, such as PHS base stations, or a wiring work therefore.

In addition, talking between a first child terminal and another first child terminal and between the first child terminal and a second child terminal device can be placed on a LAN which already exists as a computer network. Further, in case where the first and second child terminals perform wireless communicate directly, a traffic increase on the LAN can be prevented.

What is claimed is:

1. An IP phone system which is connected to an Internet protocol (IP) network over which packet communication are carried out using an Internet protocol, executes voice communication by VoIP (Voice over IP) that exchanges voice packets using said Internet protocol, and includes:
a computer device, connected to said IP network which is connected to said IP network and perform protocol conversion between said Internet protocol and another wireless communication protocol;
a first child terminal device which connects to said computer device by wireless communication by said wireless communication protocol and executes voice communication with another telephone terminal over that IP network to which said computer device is connected; and
a gate keeper device which is connected to said IP network and executes call control with respect to said computer device,
a same identifier according to said wireless communication protocol being set to said computer device and said first child terminal device,
whereby said computer device performs call and reception control when a communication link to said first child terminal device is formed.

2. The IP phone system according to claim 1, wherein said system further includes a second child terminal device which connects to said computer device by wireless communication by said wireless communication protocol and executes voice communication with another telephone terminal over that IP network to which said computer device is connected, and an identifier different from that set to said computer device is set to said second child terminal device, and
in case where a communication link to said second child terminal device is formed, said computer device performs call control according to a decision on whether a calling process is possible or not when detecting ringing from said second child terminal device.

3. The IP phone system according to claim 1, wherein when detecting an incoming call from said IP network, said computer device performs reception control in case where a communication link to said first child terminal device is formed.

4. The IP phone system according to claim 1, wherein said computer device sets identifiers respectively corresponding to a plurality of first child terminal devices in accordance with a reception priority order, and performs reception control for said first child terminal devices to which said identifiers according to said reception priority order are set, when detecting an incoming call from said IP network.

5. The IP phone system according to claim 1, wherein when detecting an incoming call from said IP network, said computer device notifies absence information to said gate keeper device in case where a communication link to said first child terminal device is not formed.

6. The IP phone system according to claim 1, wherein when detecting an incoming call from said IP network, said computer device returns an absence message to a caller in case where a communication link to said first child terminal device is not formed.

7. The IP phone system according to claim 1, wherein said gate keeper device is a gate keeper which has an H.323 communication control function.

8. The IP phone system according to claim 1, wherein said computer device has a gateway function which performs protocol conversion.

9. The IP phone system according to claim 1, wherein said computer device has a communication interface circuit which conforms to a Bluetooth (registered trademark) technical specification, and performs protocol conversion between a wireless communication protocol according to said technical specification and said Internet protocol.

10. The IP phone system according to claim 1, wherein said first child terminal device has a communication interface circuit which conforms to a Bluetooth technical specification.
